(19) United States
(12) Patent Application Publication
(10) Pub. No.: US 2014/0259168 A1
(43) Pub. Date: Sep. 11, 2014

(54) MALWARE IDENTIFICATION USING A HYBRID HOST AND NETWORK BASED APPROACH

(71) Applicant: Alcatel-Lucent USA Inc., Murray Hill, NJ (US)

(72) Inventors: Kevin McNamee, Ottawa (CA); Darren Deridder, Ottawa (CA)

(73) Assignee: Alcatel-Lucent USA Inc., Murray Hill, NJ (US)

(21) Appl. No.: 13/794,142

(22) Filed: Mar. 11, 2013

(51) Int. Cl. G06F 21/56

(52) U.S. Cl. CPC G06F 21/56
USPC 726/23

(57) ABSTRACT

Identifying malware on a user device allows corrective actions, such as removing the malware, to be taken. Malware can be detected using a hybrid approach that uses both network based devices and an agent running on the user device. The network based devices can detect network traffic associated with malware that is sent to or from the user device. A notification can be generated and sent to the user device, which uses information in the notification to identify possible malware on the user device.

### TECHNICAL FIELD

The current disclosure relates to the identification of malware on a device and in particular to identifying malware on a device through network communication from the device.

### BACKGROUND

Malicious software, or malware, is often used by attackers to disrupt normal computer operations or utilize an infected computer to perform undesirable actions. Host based anti-virus products use signature based technologies to identify files that contain malware. The anti-virus signatures are constructed based on specific file content. To avoid detection, the author of a particular malware species can use several obfuscation techniques to hide their malware. This can involve creating polymorphic malware where each malware file looks different and requires a new signature. It can also involve concealing the malware payload as a “Trojan” inside what otherwise look like legitimate applications. In these cases each new version of the malware will require a new signature and the anti-virus vendors struggle to keep their signature sets up to date.

Most modern malware species are organized into botnets that use network based command and control protocols to communicate with the malware operators. These command and control activities are characteristic of a specific malware species and can be detected by network based sensors. A key aspect of network based detection is the fact that the command and control protocol remains constant throughout the life of the malware species and can be used to detect the malware regardless of the polymorphic techniques used to conceal the files used to distribute the malware. However, network based solutions are limited in their ability to identify the source of the malware on the host device.

Therefore there is a need for an improved method for malware identification.

### BRIEF DESCRIPTION OF THE DRAWINGS

Embodiments are described herein with references to the appended drawings, in which:

FIG. 1 depicts an environment for identifying malware on a computing device using a hybrid malware identification system;

FIG. 2 depicts a process flow diagram for a hybrid malware identification process;

FIG. 3 depicts components of a user computing device for use in a hybrid malware identification system;

FIG. 4 depicts components of a network device for use in a hybrid malware identification system;

FIG. 5 depicts a method of malware identification on a user computing device in cooperation with a network device; and

FIG. 6 depicts a hybrid method of malware detection.

It will be noted that throughout the appended drawings, like features are identified by like reference numerals.

### DETAILED DESCRIPTION

In accordance with an aspect of the present disclosure there is provided a method of malware identification. At a computing device a notification is received that network traffic sent to or from the computing device through a network is related to malware, the notification including information identifying one or more of attributes determined from the malware related network traffic to aid in identifying the malware on the computing device. The computing device determines one or more processes that may have been responsible for sending or receiving the malware related network traffic on the computing device based on the information identifying the one or more attributes. The computing device identifies the determined one or more processes as possible malware.

In accordance with another aspect of the present disclosure there is provided a system for detecting malware on computing devices. A Network Intrusion Detection System (NIDS) comprises a network interface for monitoring traffic on a network, including network traffic sent to or from computing devices coupled to the network and a processor for executing instructions stored on a memory. The instructions when executed by the processor configuring the computing device to: receive network communications; detect network traffic associated with malware; and send a detection event based on detected network traffic. A notification service comprising a processor for executing instructions from a memory is provided. The instructions for execution by the processor configuring the computing device to: receive the detection event from the NIDS; and generate and send the notification that network traffic sent to or from a computing device is related to malware, the notification including the information on one or more of attributes determined from the malware related network traffic. A computing device comprising: a processor for executing instructions from a memory. The instructions when executed by the processor configuring the computing device to: receive the notification from the notification service that network traffic sent to or from the computing device is related to malware, the notification including information on one or more of attributes determined from the malware related network traffic to be used in identifying the malware on the computing device; determine one or more processes possibly responsible for sending or receiving the malware related network traffic based on the information on the one or more attributes; and identify the determined one or more processes as malware.

In accordance with still yet another aspect of the present disclosure there is provided a computing device comprising a memory and processor. The processor executing the instructions from the memory for receiving the notification from a notification service that network traffic sent to or from the computing device is related to malware, the notification including information on one or more of attributes determined from the malware related network traffic to be used in identifying the malware on the computing device. One or more processes are determined that are possibly responsible for sending or receiving the malware related network traffic based on the information on the one or more attributes. The determined one or more processes as malware are identified.

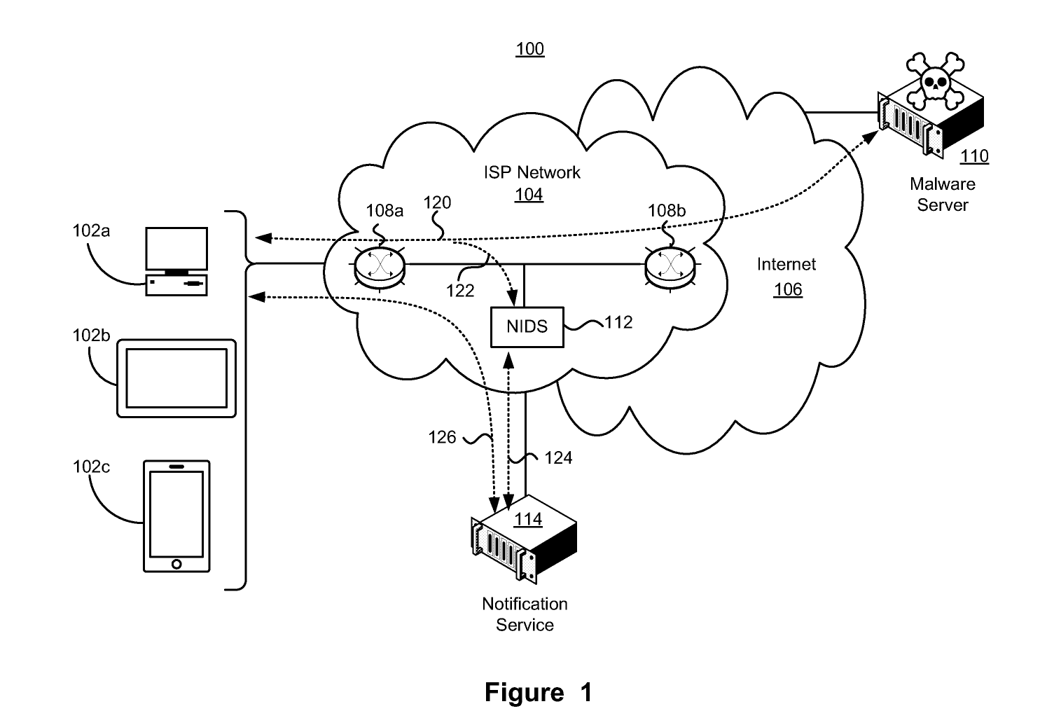

Embodiments are described below, by way of example only, with reference to FIGS. 1-12. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Identifying malware on computers allows corrective measures, such as removing or quarantining infected files, to be taken. As described further herein network based malware detection may co-operate with a host based anti-virus agent to enable the identification, and possibly the elimination, of malware that has somehow bypassed host based anti-virus detection present on the host. A network based component detects malware activity based on known command and control activity. Information on this detection event is provided to the host based agent, which attempts to identify applications that may be responsible for the malware. The information may be used to determine which applications could be responsible for the malware network communications for example by determining applications that were running on the host at the time of the detection event, installation logs, application certificates, information on statistical analysis of application manifests (permissions, receivers and services), or Bayesian probability classification of possible malware applications. Once possible malware applications are identified corrective measures can be taken such as removal of the malware and associated files from the host.

As described further herein, a hybrid malware identification system may comprise a host based component and a network based component. The host based component includes a virus scanning component that uses a signature/fingerprint based approach for identifying malware. The network based component allows the identification of communications associated with malware, and as such identification of computers infected with malware. Once the network based component detects malware communications, it may communicate with the host based component on the identified computer in order to provide the host based component with information for use in attempting to identify the malware, which the signature/fingerprint virus scanner of the host computer did not detect. As described further below, the hybrid malware detection may use a host based scanning component to identify malware on a computer for which an existing signature/fingerprint is available at the host computer, as well as a network based component for identifying potentially malicious communications from a computer and providing information useful in attempting to identify a process, application, component or file infected with malware.

FIG. 1 depicts an environment for identifying malware on a computing device using a hybrid malware identification system. The environment 100 comprises a number of components connected together through a network or networks. The networks comprise an Internet Service Provider's (ISP) network 104 as well as other interconnected networks forming the Internet 106. A number of user devices 102a, 102b, 102c (referred to collectively as user devices 102), such as personal computers, tablets and smartphones or other Internet connected computing devices, are connected to the Internet 106 through an ISP's network 104. The ISP's network 104 comprises a number of interconnected routers 108a, 108b for controlling network traffic. As will be appreciated, the ISP network 104 and other networks 106 allow the user devices 102 to communicate with other devices connected to the networks, including undesirable servers such as malware server 110 which may be a command and control server.

The ISP network 104 further comprises one or more Network Intrusion Detection Systems (NIDSs) 112. A NIDS 112 may function as a communication tap that receives a copy of the network traffic or may be deployed as an inline device in the communication path. The NIDS 112 may process the communication traffic for various purposes such as network intrusion detection; network based malware detection as well as hybrid malware detection as described further herein. One or more of these features may be provided to a subscriber of the ISP as an add-on service, as a standard feature, or on an opt-in or out-out basis. The NIDS 112 is depicted as a tap-type device; however, it is contemplated that the NIDS 112 could also function as an in-line device. If the NIDS 112 is implemented inline in the communication path it may cause an additional delay in the communication path, and as such it may be more desirable for the NIDS 112 to process copies of the network traffic without interrupting the traffic. The NIDS 112 may also communicate with devices connected to the ISP network 104 including for example a notification service 114. Although depicted as being connected to the ISP network, the notification service may be connected to the Internet 106. As described further herein, the notification service 114 may provide notifications to host devices when malware related communications are detected. The notification service 114 may further aid the NIDS 112 in determining if communication coming from, or going to, a user device is associated with malware. For example, the notification service 114 may provide the NIDS 112 with a list of known malware servers, which would allow the NIDS 112 to determine if communication to or from the user devices 102 is from a malware server 110. Additionally or alternatively, the NIDS may receive rules defining criteria for identifying malware, heuristics or other information for use in identifying potential malware communications. Additionally or alternatively, the NIDS 112 may forward intercepted communications to the notification service 114 for processing.

One or more NIDS 112 (one is depicted in FIG. 1) may be deployed in the service provider network so that the NIDSs 112 have visibility into traffic to and from the user devices. The NIDS 112 provides an intrusion detection system that can inspect network traffic and detect potential malware communications. When malware communication is detected an alert can be sent to the notification service 114 that can aggregate and store the alert information. The notification service 114 can send a notification to the user, for example via e-mail or text message, or to a software agent running on the user's device, indicating that potential malware communications were detected. The notification may include information that may be useful in determining which application, process, component, or file is responsible for the malware communication.

As described further herein, the user devices may include a hybrid detection agent that includes a virus scanning component for identifying malware present on the user device. The virus scanning component may be signature/fingerprint based detection, however it may be based on more than just static analysis of unique patterns. The virus scanning component may miss malware, for example if it is malware for which there is no signature/fingerprint available on the host, or if the malware modifies itself to avoid detection from existing signatures/fingerprints. Assuming that a user device 102a, a host, is infected with malware that is not detected by the signature/fingerprint scanner component, the malware will communicate, or attempt to communicate, with the malware command and control server 110. Alternatively the command and control server 110 may attempt to communicate with infected user computer 102a. The attempted communication between the infected user device 102a and the malware command and control server 110 is depicted by dashed arrow 120. The NIDS 112 receives a copy of the communication, depicted by dashed line 122. The NIDS 112 may determine if the communication is associated with malware according to rules, heuristics or other techniques. If the communication is determined to be associated with malware, the NIDS 112 may communicate, represented as dashed line 124, the malware communication detection to the notification service 114, which may provide a malware notification to the user device 102a. The malware notification is depicted by dashed arrow 126. A notification processor component of the hybrid malware detection agent on the user device receives the notification and attempts to identify the infected processes, applications, components and/or files from information in the notification. As described further herein, the information included in the notification allows the notification processor to attempt to identify the malware components on the host that is responsible for sending, or receiving, the detected malware communication. The notification information may include information identifying the malware detected, information describing the severity of the malware and the threat that it presents as well as information specifying the time at which the malware associated communication was detected. The notification processor may use the notification information, as well as other information available at the host, such as permissions, software components and other behavioral traits to identify one or more potential processes, applications, components or files responsible for the malware communication. If the notification processor is able to identify a process, or processes, potentially responsible for sending, or receiving, the malware communication, an application, or applications, and associated files can be identified as malware or potential malware. As described further below, additional information may be used to identify the application (or process) responsible for the malware communication. If the user device 102a identifies the malware, or the applications, processes, components or files are possibly associated with malware, it may provide identifying information back to the notification service 114, indicated by dashed arrow 126, which may use the information to update, or create, appropriate signature/fingerprint for the malware. The user device may identify a number of potential applications, processes, components, application manifests, including but not limited to whether the application was downloaded from a 3rd party source, what permissions, receivers or services it utilizes and other behavioral traits of the possible source that may be responsible for the malware communication. Alternatively, the user device 102a may provide identifying information to an additional server that maintains information on detected malware and that may update signatures/fingerprints or other identifying information for malware.

The hybrid malware agent allows the possible detection of malware based on known signatures/fingerprints, as well as possibly identifying malware based on detected communication that is associated with malware. As such, the hybrid malware agent may provide identification of malware even if malware signature/fingerprints are not available, or the user device is not kept up to date. Alternatively, the hybrid malware agent may provide the identification of possible malware using only the malware communication notifications provided by the notification service 114.

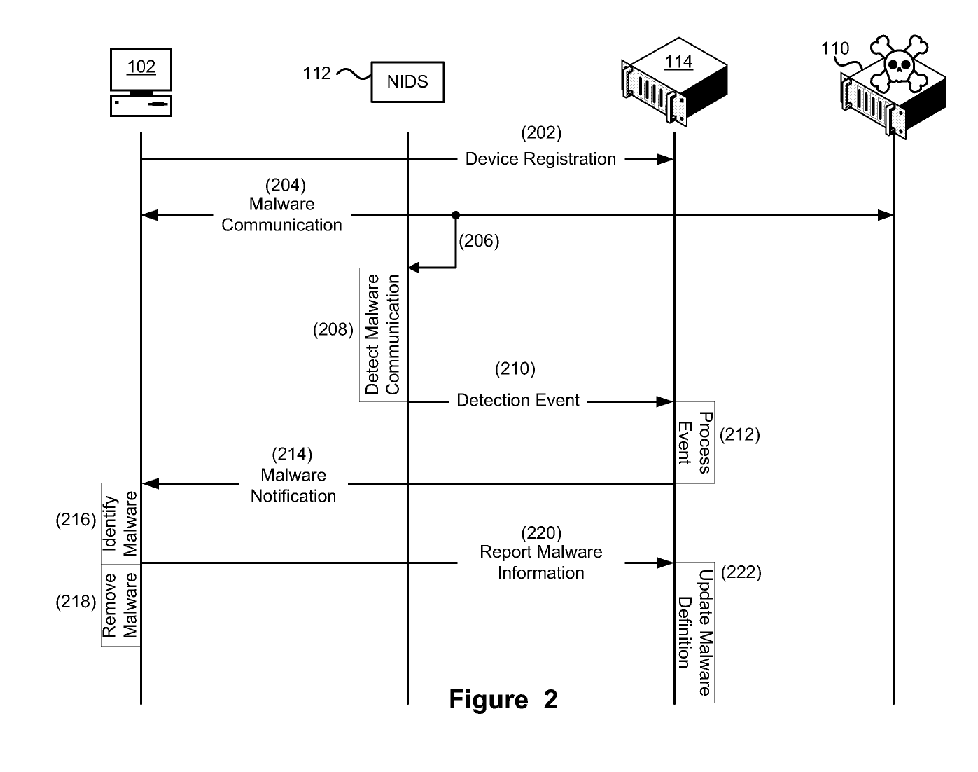

FIG. 2 depicts a process flow diagram for a hybrid malware identification process. In FIG. 2, it is assumed that the user device 102 is infected with malware that was not detected by a signature/fingerprint virus scanner on the device. Further it is assumed that the malware attempts to communicate with the malware command and control server 110. The NIDS 112 is assumed to have rules or heuristics for identifying malware communication. The process begins with the device 102 registering (202) with a notification service 114. The registration allows the identification of devices that are using the hybrid malware detection. The registration may simply involve sending a message to the notification server 114, which includes an IP address or other identifier of the device. The registration may involve a message exchange of request and acknowledgement messages that exchange a collection of information useful for registering the device such as an International Mobile Subscriber Identity (IMSI), an International Mobile Station Equipment Identity (IMEI), an operating system (OS) identifier, phone number, or other appropriate identifiers. The registration process may assign a unique ID to a device when it is registered.

At some point following the registration, the malware executing on the device 102 will attempt to communicate (204) with the malware server 110. The communication passes over the ISP network where a NIDS 112 copies the communication (206) and processes it in order to detect possible malware communications (208). Determining if the communication is associated with malware may involve checking to see if a source or destination of the communication is associated with a known malware server 110. Additionally, or alternatively, the detection of communications associated with malware may be more complex and may involve an inspection of communication headers, the body of the communications, as well as the order and timing of the communications sent. The detection of malware related communication may be based on a set of rules or heuristics, which may be periodically updated to maintain a current set of rules for detecting known. Although depicted as occurring at the NIDS 112, the NIDS 112 may identify communications that could be used to identify malware communication and forward the identified possible communications onto one or more servers for further processing and determining if the communications are associated with malware.

Assuming that the detection of malware related communication is carried out at the NIDS 112, a malware detection event is generated and sent (210) to the notification service 114 when the communication is determined to be related to malware. The notification service 114 receives the detection event and processes the detection event (212). The detection event may be processed in order to identify a user device associated with the detection event. The user device identification may be based on the registration of the device. For example, the device may register with the notification service in order to allow a user device to be associated with a network address or other device identifying characteristic of the detection event. The processing of the detection event may further comprise determining if a notification should be sent to the user's device. The determination of whether to send a notification or not may be based on various factors, including if any notifications have been sent previously, the number of notifications previously sent, the time since the last notification was sent, the severity or threat level of the detected malware, if the same malware was previously detected, user preferences for notifications or other factors. By identifying the user device associated with the detection event, it is possible to base the sending of notifications on the user device, which would be infected with the malware, as opposed to the network address used by the user device, which may have numerous different devices connected at various different times.

The detection event received at the notification service may include information such as the source and destination of the malware communication as well as a time the communication occurred at as well as the identity of the malware, meta data describing its severity and threat level, and possibly other known properties of the malware such as permissions required by the malware and/or receiver components or services used by the malware. Once the device is identified, the notification service 114 determines if the device is registered, and if it is a malware notification message is sent (214) to the user device, assuming that the processing of the detection event (212) determined that a notification should be sent. The malware notification message includes information that may be used by the device in attempting to identify the malware. The notification information may include the identity of the malware, meta-data describing its severity and threat level and the time the communication occurred at as well as other information such as permissions, receiver components or services required by the malware. Due to differences in the time at each device, the time of the communication may be an absolute time, or as a relative time, for example 5 seconds ago. The user device 102 receives the notification and attempts to identify the malware using the notification information. The malware identification may be accomplished by using available information, including information from the notification, to determine the likelihood that a process, application, component or file is associated with malware. Determining the likelihood may be based on a set of rules or heuristics. The malware identification process may determine which process or processes (or applications) are most likely responsible for the malware communication by using a set of rules and/or heuristics. For example, the malware identification process may apply criteria to each possible process such as determining which processes are running at the time the notification is received and/or the approximate time the malware communication was sent. Further, processes that are known to be associated with standard features of the operating system may be removed from consideration, or given less likelihood of responsibility for the malware communication. In addition, processes with only inconsequential user level permissions may be removed from consideration, or given less likelihood of responsibility for the malware communication, as malware often requires higher level permissions, or processes that do not have permission to use resources of the computing device that would be required to operate malware may be eliminated. Processes may be further limited by determining when the application associated with the process was installed as well as where the application was installed from, since malware will typically attempt to communicate with command and control servers once the malware is installed. In addition the criteria may include verification or validation of certificates associated with identifying the source of processes or applications as being trusted. The possible processes may be determined by applying criteria, and providing a possible score of likelihood that it may be associated with malware to reduce the possible processes that may be responsible for malware. If the process associated with the notification information is identified, the process can be stopped, and the associated application and files removed (218). The notification process may prompt the user to approve of any changes, such as stopping or removing an application, before the action is carried out. Additionally, information about the identified malware can be reported (220) to the notification service or other services which can use the information to create or update signature/fingerprint definitions (222). The updated signature/fingerprint definitions may be distributed to other user devices so that the identified malware can be detected by the signature/fingerprint scanning component.

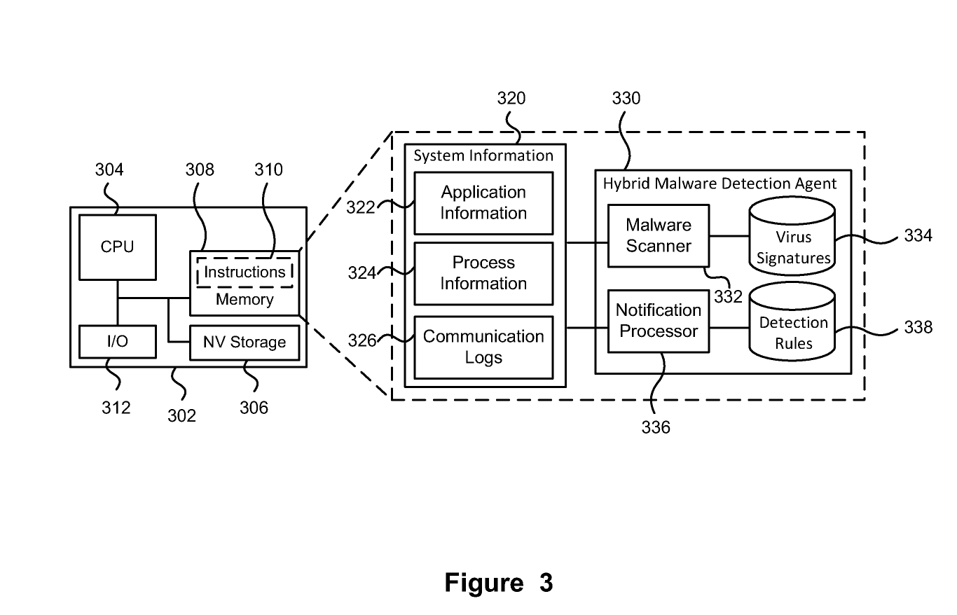

FIG. 3 depicts components of a user device for use in a hybrid malware identification system. The user device 302 comprises a central processing unit (CPU) 304 for executing instructions to configure the user device 302 to provide various functionality. The user device 302 may further comprise non-volatile storage 306 that provides permanent or semi-permanent storage of instructions and data. The device 302 may further comprise a memory unit 308 that stores instructions 310 for execution by the CPU 304. The memory 308 may further store data for use by the CPU 304. The user device 302 may further comprise one or more input/output I/O interfaces 312. The I/O interfaces may include for example a network interface for connecting the user device to a network.

The instructions 310 when executed by the CPU 304 configure the device 302 to provide various functionality. The functionality may include an operating system (OS) that provides an execution environment for different applications. The OS may provide various system information 320 or access to the system information, which may be stored in non-volatile storage. The system information may include application information 322 providing information on installed applications, such as when the application was installed, files used by the application, the last time it was executed, the location of associated files, as well as other information. The system information 320 may further comprise process information 324 that provides information on processes such as what process are currently executing, what processes were previously executing, resources accessed by the process, an application associated with the process, privileges associated with the process as well as other information related to processes. The system information 320 may further comprise communication logs 326 that provide information about what process sent or received communications, details of the communication such as source and/or destination addresses, a time of the communication as well as other information.

The instructions 310 when executed by the CPU may further configure the device 302 to provide functionality of a hybrid malware detection agent 330. The malware detection agent 330 may include a signature/fingerprint based malware scanner component 332 and associated virus signatures 334. The malware scanner component 332, if present, scans the files and/or executing applications to determine if any of the files or applications matches one of the virus signatures 334. The hybrid malware detection agent 330 may then remove or quarantine any files or applications determined to be infected. Although not depicted, the hybrid malware detection agent may include an update component for updating the virus signatures 334 used by the malware scanner component 332.

The hybrid malware detection agent 330 may further comprise a notification processing component 336. The notification processing component 336 processes received notification in an attempt to identify malware not detected by the fingerprint based scanner 332, based on information provided by a network component as well as information available at the host device. The network component is located within an ISP network and processes communications sent from the user device 302 in order to detect communications that are associated with malware. Once the network component detects malware related communications, a notification may be sent to the user device. The notification processing component 336 receives the notification and attempts to identify the malware using information from the notification and detection rules 338. The detection rules may provide rules or heuristics for identifying malware executing on the host using the notification information as well as other possible information.

The notification information comprises information on one or more of attributes determined from the malware related network traffic useful in identifying the malware on the computing device. The attributes such as but not limited to may be attributes of the malware itself, such as an identifier of the malware, a severity of the malware, a threat level of the malware, a threat type of the malware or other information on the malware. Additionally, or alternatively, the attributes may be attributes of the network traffic identified as being related to malware. For example, the attributes may be a time the network traffic was detected, source and/or destination network addresses of the network traffic, as well as other header information that can be used in identifying the network traffic, or possible applications, processes or services known to be sources of the malware. The notification processing component 336 attempts to determine one or more applications likely responsible for the network traffic determined to be related to malware. This may be accomplished in various ways, including statistical and/or heuristic based analysis, depending on what attribute information is included in the malware notification message. For example, if the malware notification includes malware identification information, the notification processing component 336 may determine known applications responsible for the malware. The notification processing component 336 may communicate with a server that provides information, such as the known applications associated with the malware.

The notification processing component 336 may also use the process information to determine one or more processes that were executing at the time the communication was sent. The notification processing component 336 may narrow down the processes according to detection rules and/or heuristics, attempting to ultimately identify a single process, although a number of likely processes, applications components or files may be identified.

The notification processing component 336 may attempt to identify the malware process by initially considering all processes and eliminating processes from consideration, or reducing their likelihood of being malware, based on rules or heuristics. The host based agent may have access to the device logs and can determine what processes and applications were running at the time the malware communication was detected. Any processes or applications that are not part of the standard operating system processes or applications may be considered to have a higher likelihood of being suspect. Often the malware application or process requires specific privileges or permissions to operate. The notification processing component may examine the permissions of installed applications. Those that have permissions that match the permissions used by the malware are suspect. In addition the notification processing component may use statistical analysis of the permissions, device features and software sub-component used by an application to determine its likelihood of being malicious. For most malware, the time delay between the infection and the initial contact to the command and control server is usually fairly short. So any applications that have been recently installed are suspect. The notification processing component can look for any processes or applications that are exhibiting known behaviors of the malware. For example if the malware is known to listen on TCP port 25, this can be used to by the agent to locate the application that is responsible. This behavior information can be provided in the notification message, or may be retrieved by the device. The notification processing component can use a white list of processes that are known to be associated with standard features or applications. The detection rules may further specify that the notification processing component should determine when applications associated with the remaining processes were installed. The date/time of installation of an application may be stored in the application information. Additionally, the application information may specify a location the application was installed from, for example if it was a 3rd party application, if the source had verification certificates, or was provided by an unverified source which may be used to determine if the process is considered to be associated with the malware.

These heuristics are used to identify the application, processes or service that could be responsible for the malware behavior observed in the network. If they result in a single suspect with high confidence, the process of removing the malware can be automatically initiated. If there are multiple candidates, or the reliability of the result is not clear, the user is provided with a short list of candidates and asked to choose what to do. The information generated by the notification processing component may be stored for use with a subsequent notification. For example, if a notification is received and the notification processing component determines that there were two possible processes running at the time, the notification processing component may store this information, and at a later time may receive another notification. It may then determine that only one of the previous two processes were executing for both notifications. The notification processing component may identify processes, applications and or files that may be infected with malware. Once identified, the malware may be removed or quarantined. Information identifying the malware may be sent to a notification service for updating or creating a signature/fingerprint capable of identifying the malware.

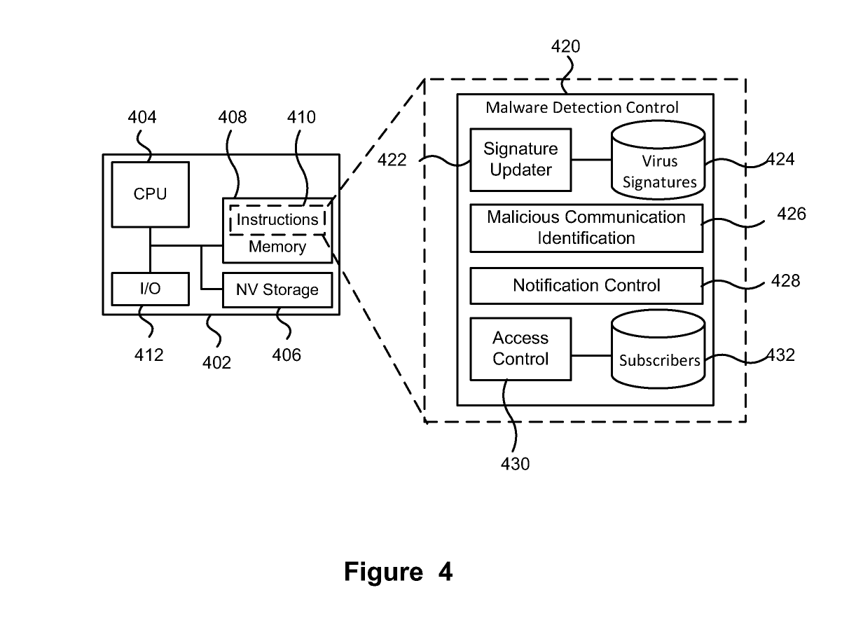

FIG. 4 depicts components of a network device for use in a hybrid malware identification system. The network device 402 may be used as the NIDS described above and may comprise a central processing unit (CPU) 404 for executing instructions to configure the network device 402 to provide various functionality. The network device 402 may further comprise non-volatile storage 406 that provides permanent or semi-permanent storage of instructions and data. The device 402 may further comprise a memory unit 408 that stores instructions 410 for execution by the CPU 404. The memory 408 may further store data for use by the CPU 404. The network device 402 may further comprise one or more input/output I/O interfaces 412. The I/O interfaces may include for example a network interface for connecting the user device to a network. Although depicted as a single computing device 402, the network device may be provided by a plurality of computing devices connected together. Further, the functionality described further below may be provided by separate components. For example, the network device is described as providing both a component for identifying malicious communication as well as providing notifications to users. The functionality may be distributed across different components in the network, for example and with reference to FIG. 1, the functionality described as being provided by the network device 402 may be distributed across one or more NIDS 112 and one or more notification services 114.

The instructions 410 when executed by the CPU 404 may configure the network device 402 to provide various functionality, including malware detection control functionality 420. The malware detection control functionality 420 may comprise a signature updater component 422 for receiving information on new or updated detections rules for detecting the presence of malware communication in the network traffic. The malware rules may also be used for identifying the malware responsible. The updated or created detection rule may be stored in a signature database 424 or other storage structure.

The malware detection control 420 may further comprise malicious communication identification functionality 426 that receives communications from the ISP network and determines if the communications are associated with malware communication. The malicious communications may be identified using various communication characteristics that are associated with known malware. The characteristics may include the source or destination of the communication, such as communications to a known command and control server. Other characteristics may include information contained in the header of the communication, the frequency of communications, or other identifying characteristics. Once a communication is identified as being associated with malware, a notification may be generated. A notification control component 428 receives information of the identified communication, such as the source and destination and the time of the communication, as well as possible other information, such as header information, and determines if the user device associated with the communication is registered with the network device. If the user is registered with the network device, the notification control may send the notification, including the identified communication information to the user device. An access control component 430 may provide information to the notification control component as to whether or not a user device is registered with the network device. The access control component 430 may receive registration information from devices and determine if they are subscribed to the hybrid malware service. The notification sent to registered user devices allows the hybrid scanner component on the device to identify the malware and take corrective actions.

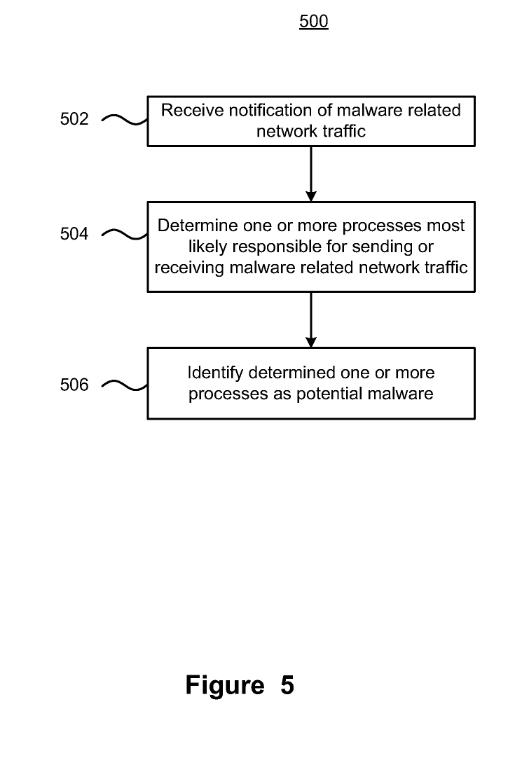

FIG. 5 depicts a method of malware identification on a user computing device in cooperation with a network device. The method 500 is performed by a user's computing device. This method may be executed by the notification processing component 336 of the hybrid malware detection agent 330 described above. The method 500 assumes that there is malware executing on the user's computing device that was not detected by a signature/fingerprint based scanning component. Further, it is assumed that a network based component has identified communications sent from the user's computing device as being associated with malware. The user's computing device receives a notification of malware related network traffic (502). The notification includes information on one or more attributes determined from the malware related traffic that may be useful in identifying a processes and possibly related applications responsible for the malware. The information of the one or more attributes may include an indication of when the network traffic communication occurred, an identification of the malware detected, a threat level of the detected malware, a type of the detected malware, a severity of the detected malware, as well as other potentially identifying information such as header information from the network traffic and/or permissions, device functions and software components required by the malware for its operation. The user's computing device determines one or more processes likely responsible for sending or receiving the network traffic (504) based on the information on the one or more attributes in the received notification. The determination of the process may be based on statistical or heuristic analysis of installed applications. For example, the determination may be achieved by determining what processes were running at the time the communication was sent and then eliminating processes that don't match the characteristics of known malware. These characteristics may include for example the name or identifier of the process or associated application, the date of installation of the application associated with the process, the execution history of the process, or other information or characteristics that can be used to eliminate legitimate processes from consideration. The application or applications associated with the remaining processes may be determined. Once the one or more applications likely responsible for sending or receiving the malicious network traffic is determined, they may be identified as potential malware (506). Once an application has been identified as malware, corrective actions may be taken. A user may be prompted prior to taking corrective action. For example, the corrective actions may include removing the application or process from the computing device, or preventing it from executing. Further, the corrective action may include sending the application information to a network component so that a virus signature/fingerprint may be updated or created. If it is not possible to identify with a suitable level of confidence that a process is responsible for the malware, a number of possible or likely processes may be presented to the user for possible identification of the malware, or elimination of processes and/or associated applications known not to be malware.

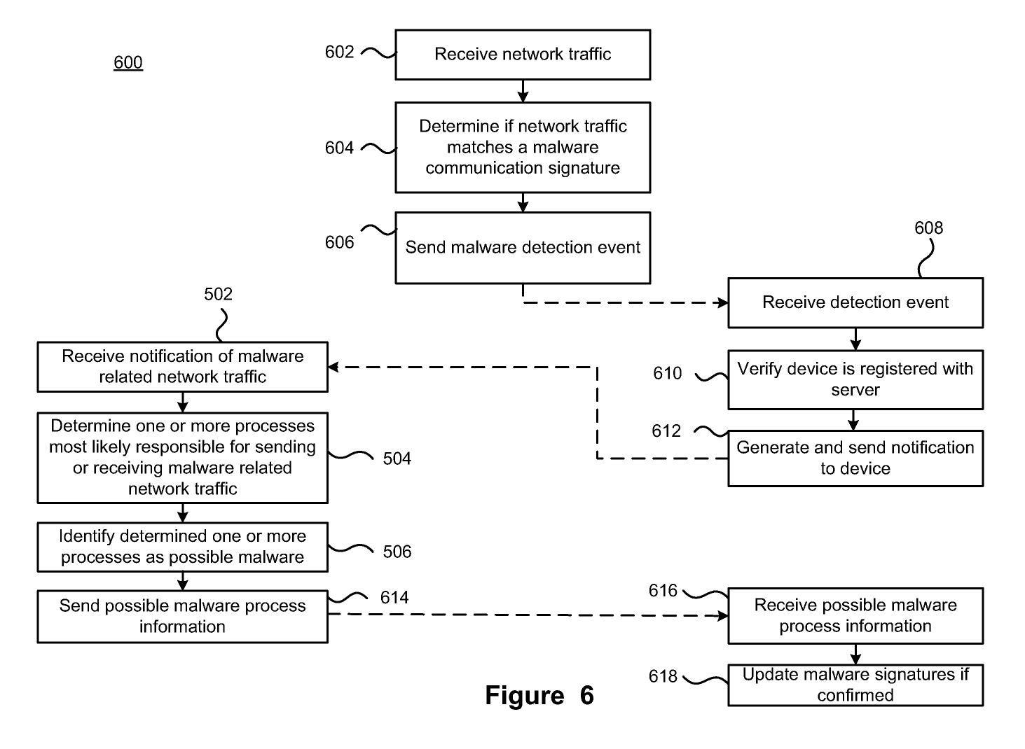

FIG. 6 depicts a hybrid method of malware detection. The method includes functions performed at different components in the computing environment. For example (602), (604), (606), (608), (610), (612), (618) and (620) may be performed by one or more network components. With reference to FIGS. 1, (602), (604) and (606) may be performed at one or more NIDS 112, and (608), (610), (612), (618) and (620) may be performed at one or more notification services 114. It will be appreciated that the steps described may be performed at different network devices, for example (502), (504), (506) and (614) may be performed by a user's computing device. In additional the functions may be divided between one or more devices or processors.

The method 600 begins when network traffic is received (602). The network traffic is processed to determine if it matches a malware communication signature (604). A malware communication signature may specify characteristics of the network traffic that may be used to reliably identify the communication as being associated with malware. For example, a malware communication signature may identify an IP address that is known to be associated with a command and control server, and as such any communications between a user device and the IP address may be reliably considered as being associated with malware. Once the network traffic is determined to be associated with malware, a malware detection event may be sent (606), for example from the NIDS to a notification service. The malware detection event is received (608) and the user device associated with the network traffic is verified as being registered with the network device (610) indicating that the user device includes hybrid malware detection functionality. Once the user device is verified a notification can be generated and sent to the device (612). The notification may include information of one or more attributes determined from the malware related network traffic as well as behavioral characteristics of the malware, such as what permissions, receivers and/or services the malware is known to use, useful in identifying the malware on the computing device. Notifications do not need to be sent for each detection event received. For example, a notification may be sent if a threshold number of detection events have been received from a user device. Additionally or alternatively, the notification may be sent if a threshold period of time has passed since the last detection event was received, or the last notification was sent. The sending of notifications may additionally be based on the malware detected. For example, notifications for more severe malware threats may be sent more often than notifications for less severe malware threats. Further, the sending of notifications may also be based on user preferences.

The device receives the notification (502), determines one or more processes likely responsible for the communication (504) and identifies the processes(s) as malware (506) as described above with regards to FIG. 5. Once processes have been identified as possible malware the user's computing device may send information of the identified processes (614) to a network device. The network device receives the process information (616) and may use it to update, or create a malware signature (618) if the possible malware processes is confirmed as being associated with the detected malware signature. The updated malware signature may be distributed to user devices so that the identified malware process or application can be determined in as part of an anti-virus signature host based application. The malware information may also be used to update rules and/or heuristics used in detecting malware related network traffic in the NIDS or provide more definitive identification of the malware to hosts devices when detected in future.

A hybrid malware detection system was described above that allows a hybrid agent on a computing device to receive notifications of malware related network traffic from a network device. The hybrid agent may identify a malware from the information of the notification. The hybrid agent allows a user device to identify malware, and so take corrective action, based on network traffic determined at a network device. The hybrid agent may further include a signature/fingerprint scanner for identifying malware based on known virus signatures. If the signature/fingerprint scanner does not detect the malware, the malware communication in the network traffic may be detected by the network devices, and as such, the malware may be detected by the notification processing component. The network devices used in detecting malware communication are typically controlled by a single entity responsible for the network or malware detection functionality, and as such maintaining the rules and/or heuristics information for identifying malware communication may be simpler than ensuring all of the user computing devices include the latest virus definitions. The network based component may identify malware communications from new viruses, or simply older viruses that a user device hasn't detected yet, and allow corrective actions to be performed at the user device. Further, it may help to quickly build a virus signature of new malware.

Although certain methods, apparatus, computer readable memory, and articles of manufacture have been described herein, the scope of coverage of this disclosure is not limited thereto. To the contrary, this patent covers all methods, apparatus, computer readable memory, and articles of manufacture fairly falling within the scope of the appended claims either literally or under the doctrine of equivalents.

Although the description discloses example methods, system and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods and apparatus, persons having ordinary skill in the art will readily appreciate that the examples provided are not the only way to implement such methods and apparatus.

What is claimed is:

1. A method of malware identification, the method comprising:
receiving at a computing device a notification that network traffic sent to or from the computing device through a network is related to malware, the notification including information identifying one or more of attributes determined from the malware related network traffic to aid in identifying the malware on the computing device;
determining at the computing device one or more processes that may have been responsible for sending or receiving the malware related network traffic on the computing device based on the information identifying the one or more attributes; and
identifying at the computing device the determined one or more processes as possible malware.

2. The method of claim 1, wherein the one or more attributes comprise one or more of:
one or more attributes of the network traffic; and
one or more attributes of the malware.

3. The method of claim 1, further comprising:
disabling the one or more processes on the computing device that have been identified as possible malware.

4. The method of claim 3, wherein disabling the one or more processes comprises at least one of:
preventing execution of the one or more processes;
preventing the one or more processes from sending or receiving network traffic;
quarantining the one or more processes; and
deleting the one or more processes from the computing device.

5. The method of claim 1 wherein the notification is received from a notification service coupled to a network.

6. The method of claim 1, further comprising:
receiving network traffic to or from the computing device at a Network Intrusion Detection System (NIDS) coupled to the network; and
determining that the network traffic is associated with malware.

7. The method of claim 6, further comprising:
generating at the NIDS the notification comprising information regarding malware related network traffic; and
sending the notification to the computing device.

8. The method of claim 6, further comprising:
generating at the NIDS a detection event including information on the one or more attributes; and
sending the detection event to a notification service.

9. The method of claim 8, wherein the one or more attributes comprise one or more of:
a time the network traffic was detected;
an identifier of the malware;
a severity level of the malware;
a threat level of the malware;
a type of the malware;
a source network address of the network traffic;
a destination network address of the network traffic; and
header information of the network traffic;

10. The method of claim 8, further comprising:
receiving at the notification service the detection event; and
sending the notification to the computing device from the notification service.

11. The method of claim 8, further comprising:
determining from the detection event if an identifier of the computing device is registered with the notification service; and
sending the notification to the computing device associated with the identifier of the computing device is registered with the notification service.

12. The method of claim 6, wherein the NIDS determines that the network traffic is associated with malware through the use of detection rules and or heuristics.

13. The method of claim 12, further comprising:
sending identifying information of the identified one or more processes from the computing device to a server for updating a signature for use at the computing device for detecting the malware.

14. The method of claim 1, wherein determining the one or more processes comprises:
determining one or more processes that were executing at a time associated with the network traffic; and
identifying the one or more processes based on characteristics of the one or more processes.

15. The method of claim 1, wherein determining the one or more processes comprises:
determining one or more processes that were executing at a time associated with receipt of the notification; and
identifying the one or more processes based on respective characteristics the processes.

16. The method of claim 1, wherein determining the one or more processes comprises:
determining applications that have been recently installed.

17. The method of claim 1, wherein determining the one or more process further comprises removing processes that are known to be associated with standard features of an operating system of the computing device and may be removed from consideration, or given less likelihood of responsibility for the malware communication.

18. The method of claim 14, wherein identifying the one or more malware applications comprises sending the determined one or more processes to a server capable of identifying the one or more malware applications from the one or more processes.

19. The method of claim 1, wherein determining the one or more malware applications further comprises:
removing processes from the possible one or more processes based upon permission level associated with the respective process.

20. A system for detecting malware on computing devices, the system comprising:
a Network Intrusion Detection System (NIDS) comprising:
a network interface for monitoring traffic on a network, including network traffic sent to or from computing devices coupled to the network;
a processor for executing instructions; and
a memory storing instructions for execution by the processor, the instructions when executed by the processor configuring the computing device to:
receive network communications;
detect network traffic associated with malware; and
send a detection event based on detected network traffic;
a notification service comprising:
a processor for executing instructions; and
a memory storing instructions for execution by the processor, the instructions when executed by the processor configuring the computing device to:
receive the detection event from the NIDS; and
generate and send the notification that network traffic sent to or from a computing device is related to malware, the notification including the information on one or more of attributes determined from the malware related network traffic; and
a computing device comprising:
a processor for executing instructions; and
a memory storing instructions for execution by the processor, the instructions when executed by the processor configuring the computing device to:
receive the notification from the notification service that network traffic sent to or from the computing device is related to malware, the notification including information on one or more of attributes determined from the malware related network traffic to be used in identifying the malware on the computing device;
determine one or more processes possibly responsible for sending or receiving the malware related network traffic based on the information on the one or more attributes; and
identify the determined one or more processes as malware.

21. A computing device comprising:
a memory for storing instructions; and
a processor coupled to the memory, the processor executing the instructions from the memory for:
receiving the notification from a notification service that network traffic sent to or from the computing device is related to malware, the notification including information on one or more of attributes determined from the malware related network traffic to be used in identifying the malware on the computing device;
determining one or more processes possibly responsible for sending or receiving the malware related network traffic based on the information on the one or more attributes; and
identifying the determined one or more processes as malware.
